(19) United States
(12) Patent Application Publication
(10) Pub. No.: US 2026/0269115 A1
(43) Pub. Date: Sep. 10, 2026

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Yuuki KAWAKAMI, Nagaokakyo-shi (JP); Kojiro KOMAGAKI, Nagaokakyo-shi (JP); Masashi HATTORI, Nagaokakyo-shi (JP)

(73) Assignee: Murata Manufacturing Co., Ltd., Kyoto-fu (JP)

(21) Appl. No.: 19/671,456

(22) Filed: May 8, 2026

Related U.S. Application Data
(63) Continuation of application No. PCT/JP2024/019491, filed on May 28, 2024.

(30) Foreign Application Priority Data
Nov. 9, 2023 (JP) 2023-191727

(51) Int. Cl. H01F 17/00

(52) U.S. Cl. CPC H01F 17/0013

(57) ABSTRACT

An inductor component includes an inductor wiring line extending along a plane, pad portions positioned at both ends of the inductor wiring line, vertical wiring lines extending from the pad portions perpendicularly to the plane, and a first magnetic layer and a second magnetic layer sandwiching the inductor wiring line in a direction perpendicular to the plane. In a sectional view orthogonal to an extending direction of the inductor wiring line, the first magnetic layer and the second magnetic layer each include an end portion including an inclined portion inclined from the direction perpendicular to the plane. Accordingly, a magnetic flux generated by the inductor wiring line is directed along one of anisotropic axes, and the influence of the other one of the anisotropic axes can be suppressed.

### CROSS-REFERENCE TO RELATED APPLICATIONS

This application claims benefit of priority to International Patent Application No. PCT/JP2024/019491, filed May 28, 2024, and to Japanese Patent Application No. 2023-191727, filed Nov. 9, 2023, the entire contents of each are incorporated herein by reference.

### BACKGROUND

### Technical Field

The present disclosure relates to an inductor component including an inductor wiring line extending in a flat plate shape.

### Background Art

Inductor components each including an inductor wiring line extending in a flat plate shape have been widespread. Such inductor components include a proposed inductor component including the inductor wiring line disposed between an upper magnetic layer and a lower magnetic layer as described, for example, in Japanese Unexamined Patent Application Publication No. 2014-199902. High inductance can be achieved by disposing the magnetic layers above and below the inductor wiring line.

### SUMMARY

In the inductor component according to Japanese Unexamined Patent Application Publication No. 2014-199902, each of the upper magnetic layer and the lower magnetic layer includes an end portion constituted by a vertical surface in a sectional view of the inductor wiring line. Accordingly, changing inductor characteristics such as inductance needs changing a wiring pattern of the inductor wiring line or forming a hole in the magnetic layers.

Therefore, the present disclosure provides an inductor component that can be changed in inductor characteristics without changing a wiring pattern of an inductor wiring line or forming a hole in a magnetic layer.

According to an aspect of the present disclosure, an inductor component includes an inductor wiring line extending along a plane; a pad portion positioned at each end of the inductor wiring line; a vertical wiring line extending from the pad portion perpendicularly to the plane; and a first magnetic layer and a second magnetic layer sandwiching the inductor wiring line in a direction perpendicular to the plane. In a sectional view orthogonal to an extending direction of the inductor wiring line, the first magnetic layer and the second magnetic layer each include an end portion including an inclined portion inclined from the direction perpendicular to the plane.

The present disclosure can provide an inductor component that can be changed in inductor characteristics without changing a wiring pattern of an inductor wiring line or forming a hole in a magnetic layer.

### BRIEF DESCRIPTION OF THE DRAWINGS

FIG. 1 is a plan view schematically showing an inductor component according to a first embodiment of the present disclosure;

FIG. 2A is a side sectional view showing a section A-A indicated in FIG. 1;

FIG. 2B is a side sectional view showing a section B-B indicated in FIG. 1;

FIG. 3 is a view schematically showing a different exemplary form of inclined portions of a first magnetic layer and a second magnetic layer in the inductor component according to the first embodiment of the present disclosure, specifically, a side sectional view showing a section positioned identically to the section shown in FIG. 2B;

FIG. 4 is a view schematically showing another different exemplary form of the inclined portions of the first magnetic layer and the second magnetic layer in the inductor component according to the first embodiment of the present disclosure, specifically, a side sectional view showing a section positioned identically to the section shown in FIG. 2B;

FIG. 5 is a view schematically showing still another different exemplary form of the inclined portions of the first magnetic layer and the second magnetic layer in the inductor component according to the first embodiment of the present disclosure, specifically, a side sectional view showing a section positioned identically to the section shown in FIG. 2B;

FIG. 6 is a graph indicating a B-H curve (magnetic hysteresis loop) provided with an easy axis and a hard axis;

FIG. 7A is a view schematically showing a method of manufacturing the inductor component according to the first embodiment of the present disclosure, specifically, a side view showing Step 1 of preparing a substrate material;

FIG. 7B is a side view showing Step 2 of stacking a first insulating layer on the substrate material subsequently to Step 1;

FIG. 7C is a side view showing Step 3 of stacking a first magnetic layer on the first insulating layer and further stacking a second insulating layer on the first magnetic layer subsequently to Step 2;

FIG. 7D is a side view showing Step 4 of forming an inductor wiring line on the second insulating layer subsequently to Step 3;

FIG. 7E is a side view showing Step 5 of stacking a third insulating layer on the second insulating layer provided with the inductor wiring line subsequently to Step 4;

FIG. 7F is a side view showing Step 6 of stacking a second magnetic layer on the third insulating layer subsequently to Step 5;

FIG. 7G is a side view showing Step 7 of forming via holes from a surface of the second magnetic layer subsequently to Step 6;

FIG. 7H is a side view showing Step 8 of forming vertical wiring lines respectively in the via holes subsequently to Step 7;

FIG. 7J is a side view showing Step 9 of grinding the substrate material to obtain a substrate having a predetermined thickness subsequently to Step 8;

FIG. 7K is a side view showing Step 10 of individualizing by means of a cutting tool subsequently to Step 9;

FIG. 7L is a side view of an inductor component formed by individualization in Step 10;

FIG. 8A is a side view showing a step of forming forward tapered surfaces in end portions of the first magnetic layer or the second magnetic layer;

FIG. 8B is a side view showing a step of forming inversely tapered surfaces in the end portions of the first magnetic layer or the second magnetic layer;

FIG. 9A is a view schematically showing an inductor component according to Variation 1 of the first embodiment of the present disclosure, specifically, a side sectional view showing a section positioned identically to the section shown in FIG. 2A;

FIG. 9B is a view schematically showing the inductor component according to Variation 1 of the first embodiment of the present disclosure, specifically, a side sectional view showing a section positioned identically to the section shown in FIG. 2B;

FIG. 10 is a view schematically showing an inductor component according to Variation 2 of the first embodiment of the present disclosure, specifically, a side sectional view showing a section positioned identically to the section shown in FIG. 2A;

FIG. 11 is a view schematically showing an inductor component according to Variation 3 of the first embodiment of the present disclosure, specifically, a side sectional view showing a section positioned identically to the section shown in FIG. 2B, in a case where the end portions of the first magnetic layer include forward tapered surfaces;

FIG. 12 is a view schematically showing the inductor component according to Variation 3 of the first embodiment of the present disclosure, specifically, a side sectional view showing a section positioned identically to the section shown in FIG. 2B, in a case where the end portions of the first magnetic layer include inversely tapered surfaces;

FIG. 13A is a side sectional view schematically showing an exemplary case in which inorganic insulating layers and inorganic magnetic layers are stacked in a stepped manner to form an inclined portion;

FIG. 13B is a side sectional view schematically showing an exemplary case in which the inorganic insulating layers and the inorganic magnetic layers are stacked in a stepped manner to form an inclined portion; and

FIG. 14 is a view schematically showing an inductor component 2 according to a second embodiment of the present disclosure, specifically, a side sectional view showing a section positioned identically to the section shown in FIG. 2B.

### DETAILED DESCRIPTION

Embodiments and variations of the present disclosure will be described hereinafter with reference to the drawings. In the drawings, corresponding members having an identical function are denoted by an identical reference sign. The embodiments may be described separately for convenience in consideration of description of the gist or ease of comprehension, although configurations described in different embodiments can be replaced or combined partially. In an embodiment to be described later, only different features will be described without repeatedly describing features in common with a former embodiment. In particular, identical or similar functional effects achieved by an identical or similar configuration will not be referred to in each embodiment. Members shown in the drawings may be exaggerated in size, positional relationship, or the like for clearer description.

The drawings show an inductor component having a substantially rectangular parallelepiped outer shape, placed in a horizontal plane, and including a substrate positioned on a lower side. The inductor component has an X axis in a longitudinal direction, a Y axis in a lateral direction, and a Z axis in a height direction orthogonal to the X axis and the Y axis.

### (Inductor Component According to First Embodiment of the Present Disclosure)

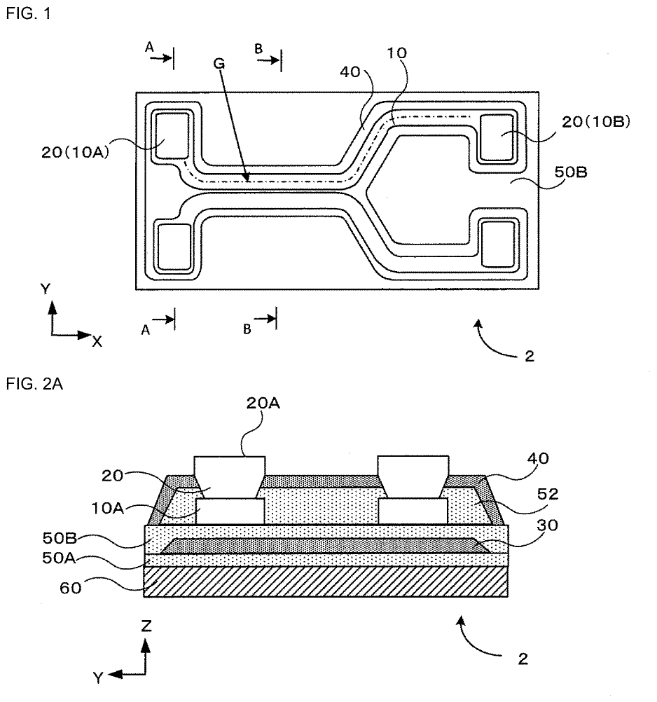

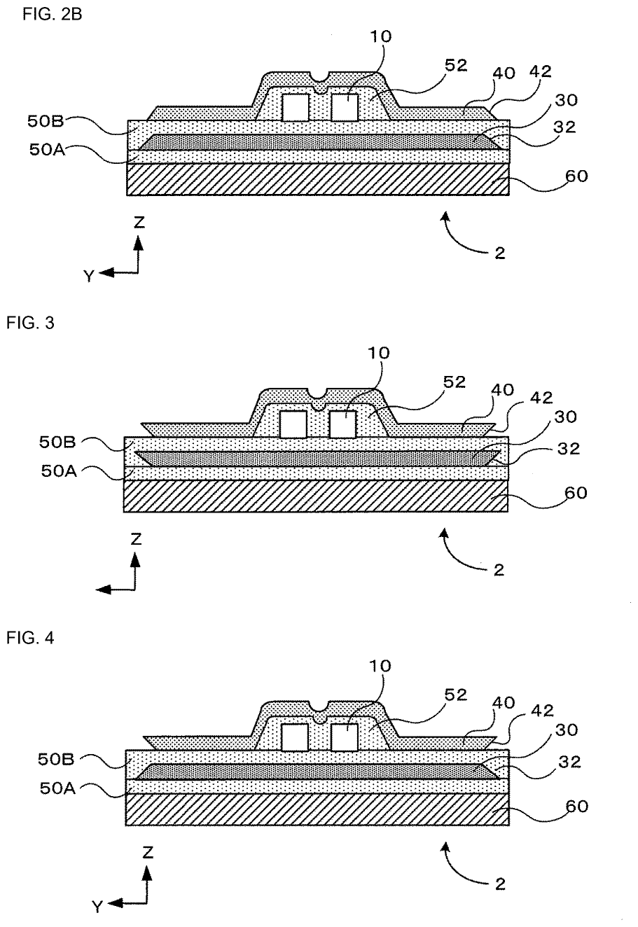

An inductor component according to the first embodiment of the present disclosure will be described initially with reference to FIGS. 1 to 5. FIG. 1 is a plan view schematically showing the inductor component according to the first embodiment of the present disclosure. FIG. 2A is a side sectional view showing a section A-A indicated in FIG. 1. FIG. 2B is a side sectional view showing a section B-B indicated in FIG. 1. FIGS. 3 to 5 are views schematically showing different exemplary forms of inclined portions of a first magnetic layer and a second magnetic layer in the inductor component according to the first embodiment of the present disclosure, specifically, side sectional views each showing a section positioned identically to the section shown in FIG. 2B.

An inductor component 2 according to the present embodiment includes a first insulating layer 50A formed on a substrate 60, a first magnetic layer 30 formed thereon, a second insulating layer 50B formed to cover the first magnetic layer 30, an inductor wiring line 10 further formed thereon, a third insulating layer 52 formed to cover the inductor wiring line 10, and a second magnetic layer 40 further formed thereon. The inductor wiring line 10 extends along a plane, and includes both ends provided with pad portions 10A and 10B. Each of the pad portions 10A and 10B at both ends is provided with a vertical wiring line 20 extending perpendicularly to the plane along which the inductor wiring line 10 extends. In the inductor component 2 according to the present embodiment, the inductor wiring line 10 is disposed between the first magnetic layer 30 and the second magnetic layer 40 in a Z axis direction. Furthermore, the first insulating layer 50A as an organic insulating layer is formed between the substrate 60 and the first magnetic layer 30 in the Z axis direction.

The present embodiment adopts a high-resistivity silicon substrate as the substrate 60. However, the substrate 60 is not limited to this configuration and examples of the substrate 60 can also include an appropriate inorganic substrate such as a glass substrate or a ceramic substrate. A highly insulating substrate is preferably adopted in view of suppressing generation of eddy current. The substrate 60 may be exemplarily 5 μm in thickness, but is not limited to this size. The inductor component 2 includes layers such as the first magnetic layer 30 formed on an inorganic substrate in the present embodiment, and can thus ensure chip strength even when the substrate is thin.

As will be described later with reference to FIG. 10, an inductor component 6 not including the substrate 60 can also be adopted.

Each of the first magnetic layer 30 and the second magnetic layer 40 is constituted by a multilayer body including an inorganic insulating layer and an inorganic magnetic layer. Each of the first magnetic layer 30 and the second magnetic layer 40 can be exemplarily about 5 μm to about 6 μm in thickness, but is not limited to this size. Each of the first magnetic layer 30 and the second magnetic layer 40 may be described in detail in terms of a material and a detailed structure thereof later in the description of a manufacturing method.

Each of the first insulating layer 50A, the second insulating layer 50B, and the third insulating layer 52 is made of polyimide in the present embodiment. However, the material is not limited to this, and examples of the material can also include other organic resins such as epoxy and phenol as well as a combination of such organic resins, and the material may contain an insulating filler. Each of the insulating layers may still alternatively be made of an inorganic insulating substance such as SiO₂ or TaO. The first insulating layer 50A may be exemplarily 5 μm in thickness in the present embodiment, but is not limited to this size. The second insulating layer 50B has a thickness of a value obtained by adding about 2 μm to about 10 μm to the thickness of the first magnetic layer 30. The third insulating layer 52 has a thickness of a value obtained by adding about 2 μm to about 10 μm to a thickness of the inductor electric wiring line 10.

In the present embodiment, two inductor wiring lines 110 are disposed along a plane and each include both ends provided with the pad portions 10A and 10B. Each of the inductor wiring lines 110 includes two regions extending parallel to the longitudinal direction (X axis direction) and connected to each other by a region extending in a direction crossing the longitudinal direction (X axis direction).

Each of the inductor wiring lines 10 and the vertical wiring lines 20 is made of a conductive material having small electrical resistance such as copper, silver, or gold. Each of the inductor wiring lines 10 and the vertical wiring lines 20 is preferably made of a conductor containing copper or a copper compound. The vertical wiring lines 20 are electrically connected to the inductor wiring lines 10 via the pad portions 10A and 10B at both ends. Each of the inductor wiring lines 10 according to the present embodiment is a rectangular wiring line having a sectional size of 40 μm×20 μm, but is not limited to this configuration. The inductor wiring line 10 can be a rectangular wiring line having a different size, or can be a wiring line other than a rectangular wiring line.

Each of the vertical wiring lines 20 has a vertical length determined in accordance with the thicknesses of the third insulating layer 52 and the second magnetic layer 40 and a protruding amount from a surface of the second magnetic layer 40. The vertical wiring line 20 according to the present embodiment has 5 μm as the protruding amount from the surface of the second magnetic layer 40, but is not limited to this amount.

The inductor component 2 configured as described above has a substantially rectangular parallelepiped outer shape with a size of L×W×T=1.0 mm×0.5 mm×0.5 mm, where L is a dimension in the longitudinal direction (X axis direction), W is a dimension in the lateral direction (Y axis direction), and T is a dimension in the height direction (Z axis direction). However, this size is merely exemplary, and an inductor component having a different appropriate outer size can be adopted.

When the vertical wiring lines 20 protruding from the surface of the second magnetic layer 40 are electrically connected to an external circuit, current flows through the inductor wiring lines 10 via the vertical wiring lines 20 to generate a magnetic flux, so that a function as an inductor can be achieved.

As shown in FIG. 2A, the vertical wiring lines 20 according to the present embodiment are formed to increase in sectional area from end surfaces in contact with the pad portions 10A and 10B to opposite end surfaces 20A. This configuration can improve connection strength on the end surfaces 20A with an external circuit or an external terminal to achieve suppression of connection electrical resistance.

As shown in FIG. 2A, the vertical wiring lines 20 extend through the second magnetic layer 40 in the present embodiment. In plan view, the second magnetic layer 40 is formed to cover the entire periphery of each of the vertical wiring lines 20, and has a region maximized in planar size. This configuration can achieve an improvement in inductor acquisition efficiency and can suppress a leakage magnetic flux.

In the inductor component 2 according to the present embodiment, the end surface 20A of each of the vertical wiring lines 20 is further provided with a plurality of conductive layers. For example, the end surface 20A can be provided with an Ni layer as a conductive layer to achieve electromigration resistance, and can be further provided with an Au layer, an Sn layer, or the like as a conductive layer to achieve wettability. This can provide appropriate functions for connection to an external circuit.

### <Inclined Portion>

As shown in FIGS. 2B and 3 to 5, the inductor component 2 according to the present embodiment includes inclined portions 32 formed in both end portions of the first magnetic layer 30 and inclined portions 42 in both end portions of the second magnetic layer 40 in a sectional view orthogonal to an extending direction of the inductor wiring lines 10.

Current flowing through each of the inductor wiring lines 10 generates a magnetic flux in a circumferential direction of the inductor wiring line 10. In a sectional view of the inductor wiring line 10, the magnetic flux travels, for example, in the Y axis direction in the first magnetic layer 30, travels from the first magnetic layer 30 to the second magnetic layer 40 in one of the end portions, travels in a direction opposite to the above in the second magnetic layer 40, and travels from the second magnetic layer 40 to the first magnetic layer 30 in the other one of the end portions. This generates a flow of the magnetic flux traveling to circulate in the first magnetic layer 30 and the second magnetic layer 40. The magnetic flux may travel in a direction opposite to the above in accordance with a direction of current flowing through the inductor wiring line 10.

In a sectional view of the inductor wiring line 10 in the present embodiment, both end portions of the first magnetic layer 30 and the second magnetic layer 40 sandwiching the inductor wiring line 10 include the inclined portions 32 and 42 to provide changes in a distribution state of the magnetic layers in the end portions. This can thus change distribution of the magnetic flux traveling between the first magnetic layer 30 and the second magnetic layer 40. More detailed description will be made hereinafter with reference to examples shown in FIGS. 2B and 3 to 5.

In this case, an inclined surface that narrows the first magnetic layer 30 or the second magnetic layer 40 toward the inside of the end portions in a direction from the first magnetic layer 30 toward the second magnetic layer 40 (in a Z axis positive direction) will be referred to as a forward tapered surface, and an inclined surface that widens the first magnetic layer 30 or the second magnetic layer 40 toward the outside of the end portions in the direction from the first magnetic layer 30 toward the second magnetic layer 40 (in the Z axis positive direction) will be referred to as an inversely tapered surface. According to the example shown in FIG. 2B, both the inclined portions 32 of the first magnetic layer 30 and the inclined portions 42 of the second magnetic layer 40 have forward tapered surfaces. The inclined portions are tapered at, for example, an angle equal to or more than 20 degrees and equal to or less than 70 degrees (i.e., from 20 degrees to 70 degrees).

Typically, the more magnetic flux passes as a magnetic layer has a larger volume. The second magnetic layer 40 has a larger magnetic layer volume in a region adjacent to the inductor wiring lines 10 whereas the first magnetic layer 30 has a smaller magnetic layer volume in a region adjacent to the inductor wiring lines 10. This configuration prevents a deviated flow of the magnetic flux in the region adjacent to the inductor wiring lines 10 or a region distant from the inductor wiring lines 10. This can balance inductance acquisition efficiency with direct current superposition characteristics.

According to the example shown in FIG. 3, both the inclined portions 32 of the first magnetic layer 30 and the inclined portions 42 of the second magnetic layer 40 have inversely tapered surfaces.

On the contrary in this example, the first magnetic layer 30 has a larger magnetic layer volume in the region adjacent to the inductor wiring lines 10 whereas the second magnetic layer 40 has a smaller magnetic layer volume in the region adjacent to the inductor wiring lines 10. This configuration prevents a deviated flow of the magnetic flux in the region adjacent to the inductor wiring lines 10 or the region distant from the inductor wiring lines 10. This can also balance the inductance acquisition efficiency with the direct current superposition characteristics.

According to the example shown in FIG. 4, the inclined surfaces of the first magnetic layer 30 are forward tapered surfaces whereas the inclined portions of the second magnetic layer 40 have inversely tapered surfaces.

The magnetic layer volume increases in the region distant from the inductor wiring lines 10 in each of the first magnetic layer 30 and the second magnetic layer 40, so that the magnetic flux passes also through a magnetic layer distant from the inductor wiring lines 10. This causes dispersion of magnetic flux density and improves the direct current superposition characteristics.

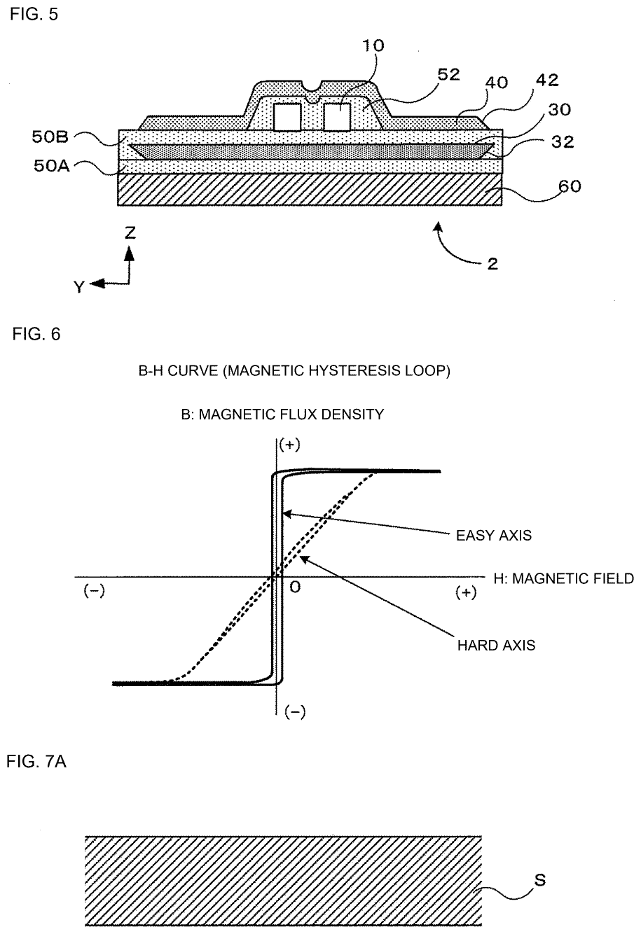

According to the example shown in FIG. 5, the inclined surfaces of the first magnetic layer 30 are inversely tapered surfaces whereas the inclined portions of the second magnetic layer 40 have forward tapered surfaces.

The magnetic layer volume increases in the region adjacent to the inductor wiring lines in each of the first magnetic layer 30 and the second magnetic layer 40, so that the more magnetic flux passes to improve the inductance acquisition efficiency.

As described above, the end portions of the first magnetic layer 30 and the second magnetic layer 40 include the inclined portions 32 and 42 in a sectional view orthogonal to the extending direction of the inductor wiring lines 10. The present embodiment can thus provide an inductor component that can be changed in inductor characteristics without changing a wiring pattern of the inductor wiring lines or forming a hole in the magnetic layers.

The end portions of both the first magnetic layer 30 and the second magnetic layer 40 are provided with the inclined portions 32 and 42 in the embodiment described above. However, the above effect will be achieved if the end portions of at least one of the magnetic layers are provided with the inclined portions 32 or 42. The inductor characteristics can be changed also by changing widths of the first magnetic layer 30 and the second magnetic layer 40 in addition to provision of the inclined portions 32 and 42.

### <Extending Direction of Inductor Wiring Line>

The inductor component 2 having the substantially rectangular parallelepiped outer shape includes the pad portions 10A and 10B in both end regions in the longitudinal direction (X axis direction). In the present embodiment, the two inductor wiring lines 10 are disposed along the plane as described above, and each of the inductor wiring lines 10 includes the two regions extending parallel to the longitudinal direction (X axis direction) and connected to each other by the region extending in the direction crossing the longitudinal direction (X axis direction).

However, the inductor wiring lines 10 are not limited to such a form. An inductor may include a meander wiring line extending in the longitudinal direction (X axis direction) while meandering. In this case, an inductor wiring line may include linear portions extending in the longitudinal direction (X axis direction) and linear portions extending in the lateral direction (Y axis direction) connected alternately, or an inductor wiring line may extend in the longitudinal direction (X axis direction) while meandering to draw a smooth curve. Furthermore, an inductor may include a spiral wiring line making one or more turns (360 degrees or more).

### <Uniaxial Magnetic Anisotropy>

The first magnetic layer 30 and the second magnetic layer 40 have uniaxial magnetic anisotropy in an identical direction in the present embodiment. The first magnetic layer 30 and the second magnetic layer 40 according to the present embodiment have two anisotropic axes (an easy axis and a hard axis) that are parallel to the longitudinal direction (X axis direction) and the lateral direction (Y axis direction) of the inductor component 2 in plan view (see FIG. 1). A state where “the first magnetic layer 30 and the second magnetic layer 40 have uniaxial magnetic anisotropy in an identical axis direction” means that the anisotropic axes of the first magnetic layer 30 and the second magnetic layer 40 form an angle in a range less than 10 degrees in consideration of manufacturing variations.

As described above, each of the inductor wiring lines 10 according to the present embodiment includes the two regions extending parallel to the longitudinal direction (X axis direction) and connected to each other by the region extending in the direction crossing the longitudinal direction (X axis direction). Both ends of the inductor wiring line 10 are thus disposed to be distant from each other in the direction (X axis direction) of one of the anisotropic axes including the hard axis and the easy axis in uniaxial magnetic anisotropy.

Furthermore, the inductor wiring line 10 extends without ever being orthogonal also in the region extending in the direction crossing the direction (X axis direction) of one of the anisotropic axes. That is, the inductor wiring line 10 extends without being orthogonal to one of the anisotropic axes (X axis) in the entire region.

Described in detail with reference to FIG. 6 are the anisotropic axes of the first magnetic layer 30 and the second magnetic layer 40 having uniaxial magnetic anisotropy in the identical axis direction. FIG. 6 is a graph indicating a B-H curve (magnetic hysteresis loop) provided with the easy axis and the hard axis.

An exemplary method of measuring an easy axis direction and a hard axis direction of uniaxial magnetic anisotropy includes rotating a test sample by 90 degrees and measuring a magnetic layer with use of a VSM (vibrating sample magnetometer) to obtain a B-H curve.

The B-H curve is also referred to as a magnetic hysteresis loop. FIG. 6 indicates an exemplary B-H curve thus measured. The graph shown in FIG. 3 includes an ordinate axis indicating magnetic flux density B (unit: T) and a transverse axis indicating magnetic field intensity H (unit: A/m).

When magnetic permeability is denoted by μ, the relationship B=μH is established. That is, the B-H curve in FIG. 6 has an inclination indicating the magnetic permeability a. A steeply rising B-H curve indicates the easy axis (easy magnetization axis) whereas a gently inclined B-H curve indicates the hard axis (hard magnetization axis). The inductor acquisition efficiency can be improved if the direction of the magnetic flux generated by current flowing through the inductor wiring line 10 is parallel to the easy axis. In contrast, the direct current superposition characteristics can be improved or iron loss can be reduced if the direction of the magnetic flux generated by current flowing through the inductor wiring line 10 is parallel to the hard axis. The test sample for uniaxial magnetic anisotropy preferably has a circular or square planar shape to exclude the influence of shape anisotropy, but measurement can be executed even when the test sample has a shape other than the above.

The present embodiment allows both a case where the hard axis of the first magnetic layer 30 and the second magnetic layer 40 having uniaxial magnetic anisotropy is directed in the longitudinal direction (X axis direction) and the easy axis thereof is directed in the lateral direction (Y axis direction) and another case where the easy axis is directed in the longitudinal direction (X axis direction) and the hard axis is directed in the lateral direction (Y axis direction).

Each of the inductor wiring lines 10 can be extended without being orthogonal to one of the anisotropic axes (X axis) in the entire region not only in a case where the inductor wiring line 10 has a planar shape as shown in FIG. 1, but also in a case where, for example, the inductor wiring line 10 extends in a direction along one of the anisotropic axes (X axis direction) while meandering.

In this case, the inductor wiring line 10 extending between the pad portions 10A and 10B at both ends constantly has a vector component in the direction along one of the anisotropic axes (X axis direction). The inductor wiring line 10 never has only a vector component in a direction along the other one of the anisotropic axes (Y axis direction) without having the vector component in the direction along one of the anisotropic axes (X axis direction).

This state can also be expressed as follows: a wiring line center line G (see FIG. 1) passing through the center in a width direction of the inductor wiring line 10 extends without being orthogonal to one of the anisotropic axes (X axis direction) in the entire region. This state can also be expressed as follows: the wiring line center line G and one of the anisotropic axes (X axis direction) cross each other at an angle less than 90 degrees.

Examples of the inductor wiring line extending along a plane include the spiral wiring line. When a turn by 360 degrees of a spiral inductor wiring line is defined as one turn, the spiral inductor wiring line extending without being orthogonal to one of the anisotropic axes (X axis) can also be expressed as being constituted by connecting the inductor wiring lines 10 making less than 0.5 turns.

The inductor wiring line 10 extending in the direction along one of the anisotropic axes (X axis direction) has the vector component in the direction along one of the anisotropic axes (X axis direction). Accordingly, the magnetic flux can be mostly directed along the other one of the anisotropic axes (in the Y axis direction). If the inductor wiring line 10 includes a region extending perpendicularly to the direction along one of the anisotropic axes (X axis direction), all of the magnetic flux is directed along the one of the anisotropic axes (in the X axis direction) in the region to be influenced by the one of the anisotropic axes.

In the present embodiment, the first magnetic layer 30 and the second magnetic layer 40 have uniaxial magnetic anisotropy in an identical direction, and both ends of each of the inductor wiring lines 10 are disposed to be distant from each other in the direction along one of the anisotropic axes (X axis direction) including the hard axis and the easy axis in uniaxial magnetic anisotropy, and the inductor wiring line 10 extends without being orthogonal to the one of the anisotropic axes (X axis) in the entire region.

The inductor wiring line 10 extends in the direction along one of the anisotropic axes (X axis direction) in this manner, so that the magnetic flux can be mostly directed along the other one of the anisotropic axes (in the Y axis direction). This provides an effect of directing the magnetic flux along the other one of the anisotropic axes (in the Y axis direction). In addition, the inductor wiring line 10 extends without being orthogonal to one of the anisotropic axes (X axis) in the entire region, and can thus suppress the influence of the one of the anisotropic axes (X axis). This reliably provides an effect such as an improvement in inductance acquisition efficiency, an improvement in direct current superposition characteristics, or suppression of iron loss.

When one of the anisotropic axes directed in the longitudinal direction (X axis direction) is the hard axis, the magnetic flux mostly passes through the easy axis (Y axis direction), so that inductance acquisition efficiency can be improved. In contrast, when one of the anisotropic axes directed in the longitudinal direction (X axis direction) is the easy axis, the magnetic flux mostly passes through the hard axis (Y axis direction), so that direct current superposition characteristics can be improved or iron loss can be reduced.

When the inductor component 2 has the substantially rectangular parallelepiped outer shape as described above and the easy axis is directed in the longitudinal direction of the rectangular parallelepiped, the inductor component 2 further has the following advantage. In consideration of the influence of magnetic shape anisotropy, the anisotropic axes can be controlled more easily when the easy axis is directed in the longitudinal direction. Accordingly, the inductor wiring line extends without being orthogonal to the easy axis in the entire region, so that the magnetic flux mostly passes through the hard axis, and an improvement in direct current superposition characteristics and suppression of iron loss can be achieved.

As described above, the plurality of inductor wiring lines 10 disposed along the plane includes both regions in which the inductor wiring lines 10 are disposed parallel to each other and regions in which the inductor wiring lines 10 are disposed nonparallel to each other. The regions in which the inductor wiring lines 10 are disposed nonparallel to each other form the region in which the inductor wiring lines 10 are disposed parallel and adjacent to each other and the region in which the inductor wiring lines 10 are disposed parallel and distant from each other. Such disposition can achieve an increase in coupling coefficient in the region in which the inductor wiring lines 10 are disposed adjacent to each other and a decrease in coupling coefficient in the regions in which the inductor wiring lines 10 are distant from each other. The regions in which the inductor wiring lines 10 are disposed parallel to each other are connected via the region in which the inductor wiring lines 10 are disposed nonparallel to each other, so that the inductor coupling coefficient can be variously controlled.

As shown in FIG. 2B, the second magnetic layer 40 has a protruding and recessed shape to cover the inductor wiring lines 10 in three directions in the region in which the inductor wiring lines 10 are disposed adjacent to each other. When the second magnetic layer 40 has the protruding and recessed shape to cover the inductor wiring lines 10 in the three directions in a sectional view of the inductor wiring lines 10, the first magnetic layer 30 and the second magnetic layer 40 can cover the entire peripheries of the inductor wiring lines 10, which improves the inductor acquisition efficiency.

As is apparent from FIGS. 1 and 2B, the second magnetic layer 40 is disposed inside the outer shape of the inductor component 2. There is therefore no possibility of damage to the magnetic layers due to cutting during individualization. If the magnetic layers are stretched due to mechanical stress during cutting, leakage occurs between the stacked magnetic layers, thus causing the problem of increased iron loss. The present embodiment can avoid such a problem.

The inductor component according to the present disclosure may include a meander wiring line including linear portions extending parallel to the longitudinal direction (X axis direction) and linear portions extending parallel to the lateral direction (Y axis direction) connected alternately, or may include a spiral wiring line. In such a case, the inductor wiring line is not in the state of “extending without being orthogonal to one of the anisotropic axes (X axis direction) in the entire region”.

### <Planar Shapes of Magnetic Layers>

When the plurality of inductor wiring lines 10 is disposed along the plane, each of the first magnetic layer 30 and the second magnetic layer 40 can have a planar shape close to a square shape. This can reduce the influence of magnetic shape anisotropy, and can thus allow a wider range of material selection and the like.

It is preferable that, as the shape close to the square shape, a ratio between a size in the direction along one of the anisotropic axes (X axis direction) and a size in the direction along the other one of the anisotropic axes (Y axis direction) be 0.5 or more and 1 or less (i.e., from 0.5 to 1), more preferably 0.7 or more and 1 or less (i.e., from 0.7 to 1). Also in consideration of a case where the first magnetic layer 30 and the second magnetic layer 40 do not have an identical shape, it is preferable that, when the plane in which the inductor wiring lines 10 extend is viewed perpendicularly, at least one of the first magnetic layer 30 or the second magnetic layer 40 overlap with the plurality of inductor wiring lines 10, and a ratio between a size of the outer shape in the direction along one of the anisotropic axes (X axis direction) and a size of the outer shape in the direction along the other one of the anisotropic axes (Y axis direction) be 0.5 or more and 1 or less (i.e., from 0.5 to 1), more preferably 0.7 or more and 1 or less (i.e., from 0.7 to 1).

### <Method of Manufacturing Inductor Component>

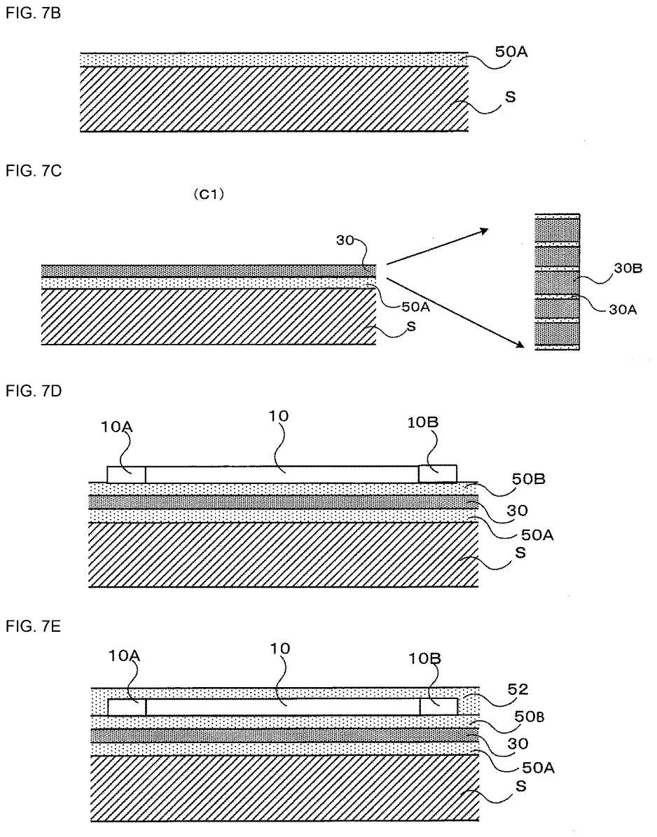

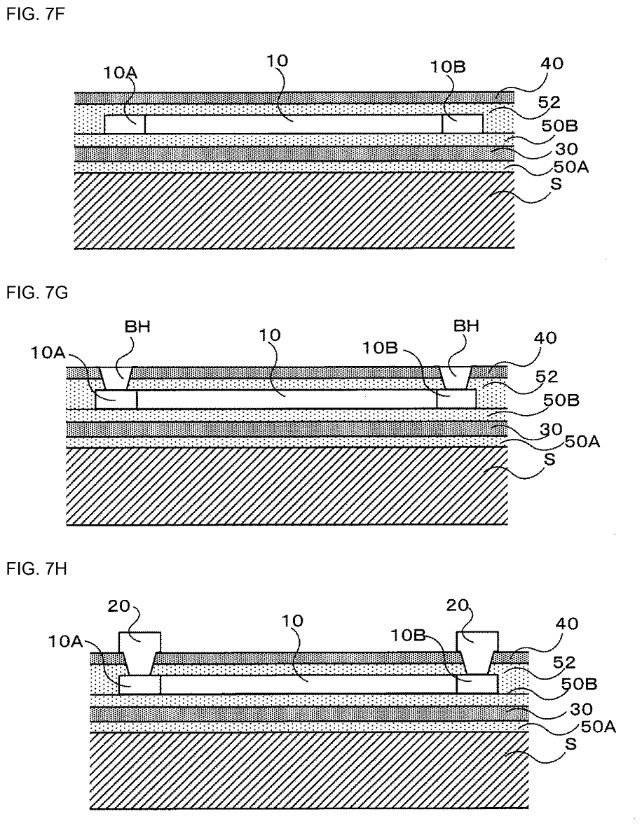

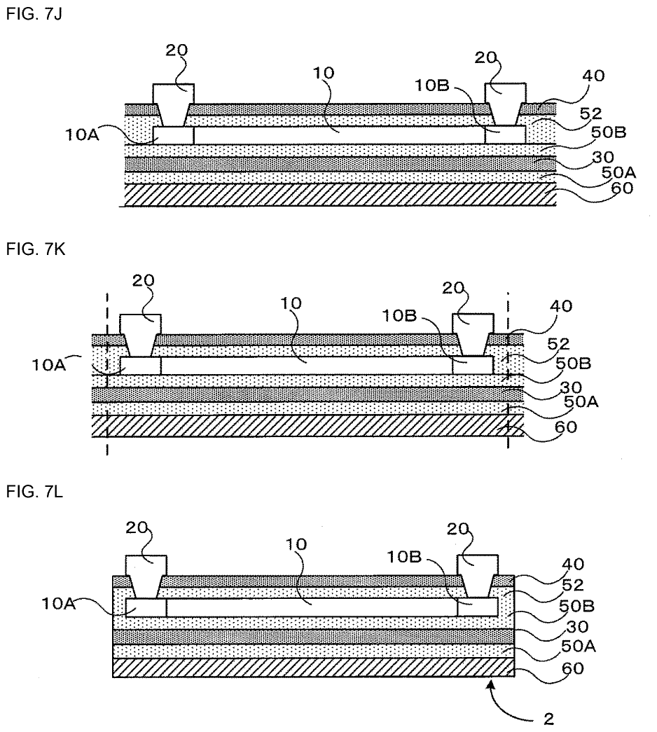

A method of manufacturing the inductor component 2 will be described next with reference to FIGS. 7A to 7L. FIG. 1 is a plan view schematically showing the inductor component according to the first embodiment of the present disclosure. FIG. 7A is a view schematically showing the method of manufacturing the inductor component according to the first embodiment of the present disclosure, specifically, a side view showing Step 1 of preparing a substrate material. FIG. 7B is a side view showing Step 2 of stacking the first insulating layer on the substrate material subsequently to Step 1. FIG. 7C is a side view showing Step 3 of stacking the first magnetic layer on the first insulating layer and further stacking the second insulating layer on the first magnetic layer subsequently to Step 2. FIG. 7D is a side view showing Step 4 of forming the inductor wiring line on the second insulating layer subsequently to Step 3. FIG. 7E is a side view showing Step 5 of stacking the third insulating layer on the second insulating layer provided with the inductor wiring line subsequently to Step 4. FIG. 7F is a side view showing Step 6 of stacking the second magnetic layer on the third insulating layer subsequently to Step 5. FIG. 7G is a side view showing Step 7 of forming via holes from the surface of the second magnetic layer subsequently to Step 6. FIG. 7H is a side view showing Step 8 of forming the vertical wiring lines respectively in the via holes subsequently to Step 7. FIG. 7J is a side view showing Step 9 of grinding the substrate material to obtain a substrate having a predetermined thickness subsequently to Step 8. FIG. 7K is a side view showing Step 10 of individualizing by means of a cutting tool subsequently to Step 9. FIG. 7L is a side view of an inductor component formed by individualization in Step 10.

These figures schematically show side sections in the extending direction of the inductor wiring line 10. The inclined portions 32 and 42 of the first and second magnetic layers 30 and 40 are formed in both end portions of the first and second magnetic layers 30 and 40 in a direction orthogonal to the figures (direction in a sectional view of the inductor wiring line 10).

### Step 1

As shown in FIG. 7A, the method initially includes Step 1 of preparing a substrate material S. The substrate material S is made of high-resistivity silicon as described above. The substrate material S shown in the figure is larger in thickness than the substrate 60 eventually finished. The step includes providing a plurality of inductor components in the single substrate material S, and then individualizing to obtain the inductor components 2.

### Step 2

As shown in FIG. 7B, the method subsequently includes Step 2 of stacking the first insulating layer 50A on the substrate material S. Specifically, polyimide as an organic resin can be applied onto the substrate material S and cured to form the first insulating layer 50A.

### Step 3

As shown in FIG. 7C, the method subsequently includes Step 3 of stacking the first magnetic layer 30 on the first insulating layer 50A (see C1) and further stacking the second insulating layer 50B thereon (see C2). Initially described is a step of stacking the first magnetic layer 30 on the first insulating layer 50A as shown in C1. As shown in an enlarged view on the right side of FIG. 7C, the first magnetic layer 30 includes a multilayer body including inorganic insulating layers 30A and inorganic magnetic layers 30B. The inorganic insulating layers 30A and the inorganic magnetic layers 30B are stacked in the mentioned order in accordance with a sputtering method or the like. Accordingly, the inorganic insulating layers 30A can also be referred to as sputtered insulating layers 30A whereas the inorganic magnetic layers 30B can also be referred to as sputtered magnetic layers 30B.

### [Method of Forming Inclined Portions]

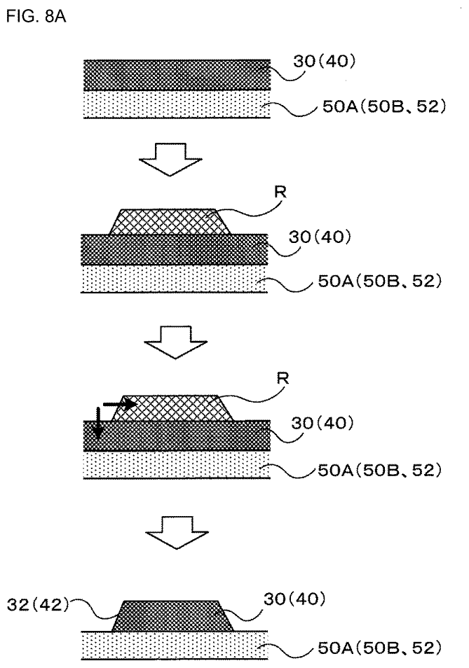

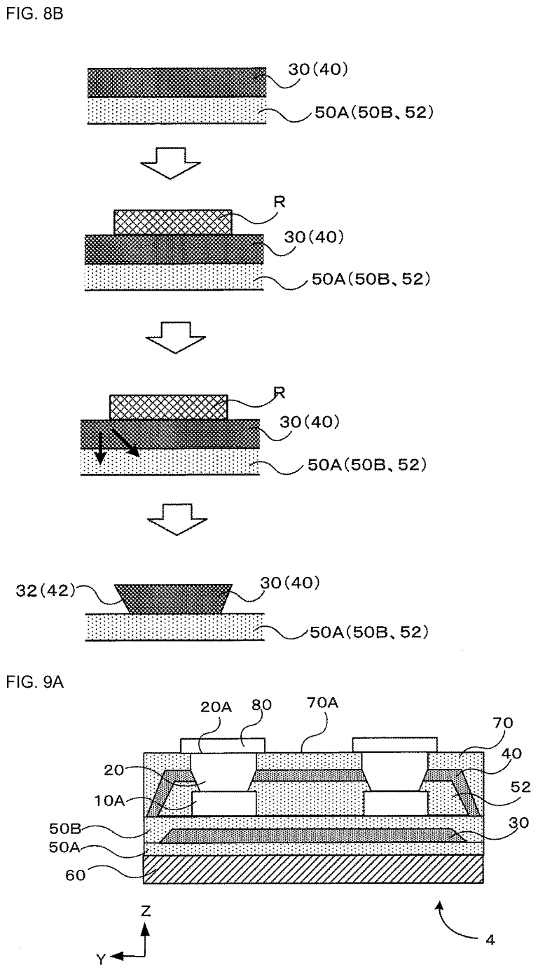

The inductor component 2 according to the present embodiment includes the inclined portions 32 and 42 in both end portions of the first magnetic layer 30 and the second magnetic layer 40 in a sectional view orthogonal to the extending direction of the inductor wiring lines 10. The method of forming the inclined portions 32 and 42 will be described with reference to FIGS. 8A and 8B. The following description will exemplify forming the inclined portions 32 on the first magnetic layer 30, whereas the inclined portions 42 are formed similarly on the second magnetic layer 40. FIG. 8A is a side view showing a step of forming forward tapered surfaces in the end portions of the first magnetic layer or the second magnetic layer. FIG. 8B is a side view showing a step of forming inversely tapered surfaces in the end portions of the first magnetic layer or the second magnetic layer.

As shown in FIG. 8A, in order to form the inclined portions 32 having the forward tapered surfaces, the first magnetic layer 30 is stacked on the first insulating layer 50A and a resist R including inclined portions having forward tapered surfaces is subsequently formed on the first magnetic layer 30. The resist Rand the first magnetic layer 30 are then dry etched. The resist R is thus etched while a thin portion (protruding portion on a lower side of the figure) is shifting backward. The first magnetic layer 30 is accordingly provided with the inclined portions having the forward tapered surfaces as shown in the lowermost illustration.

As shown in FIG. 8B, in order to form the inclined portions 32 having inversely tapered surfaces, the first magnetic layer 30 is stacked on the first insulating layer 50A and a resist R is subsequently formed on the first magnetic layer 30. When wet etching is applied, a portion immediately below the resist R (below a protruding portion on an upper side of the figure) is not etched whereas the first magnetic layer 30 is etched from a portion that is likely to be obliquely liquid-replaced, thus forming the inclined portions having the inversely tapered surfaces as shown in the lowermost illustration.

### [Method of Providing Uniaxial Magnetic Anisotropy]

The present disclosure includes the case where the first magnetic layer 30 and the second magnetic layer 40 have uniaxial magnetic anisotropy and a case where the magnetic layers do not have the uniaxial magnetic anisotropy. Described below is a manufacturing method for the case where the magnetic layers have uniaxial magnetic anisotropy.

Examples of a method of providing the first magnetic layer 30 with uniaxial magnetic anisotropy can include the following. When the inorganic magnetic layers 30B are formed in a magnetic field in accordance with the sputtering method, atoms in the inorganic magnetic layers 30B are disposed at desired positions and the easy axis can be directed in an applied magnetic field direction. The easy axis will be directed in the longitudinal direction of the inductor component 2 when the applied magnetic field direction is directed in the longitudinal direction, and the hard axis will be directed in the longitudinal direction when the applied magnetic field direction is directed in the lateral direction of the inductor component 2.

The inorganic insulating layers 30A can be made of an inorganic insulating substance such as SiO₂ or TaO. Furthermore, the inorganic magnetic layers 30B can be made of CZT (Co—Zr—Ta), an FeNi alloy, or a composite containing a magnetic material and an inorganic substance. The interlayer thickness between the inorganic magnetic layers 30B is preferably thinner than each of the inorganic magnetic layers 30B. The inorganic insulating layers 30A function to insulate the inorganic magnetic layers 30B adjacent to each other, or protect the inorganic magnetic layers 30B from processing stress. The inorganic insulating layers 30A having a smaller thickness can thus contribute to a higher magnetic layer ratio in the entire multilayer body.

As described above, the first magnetic layer 30 includes the multilayer body including the inorganic insulating layers 30A and the inorganic magnetic layers 30B, the inorganic insulating layers 30A is smaller in thickness than the inorganic magnetic layers 30B, and all the inorganic magnetic layers 30B have uniaxial magnetic anisotropy in an identical direction. This applies also to the second magnetic layer 40 to be described later.

The inorganic insulating layers 30A are smaller in thickness than the inorganic magnetic layers 30B, so that sufficient insulation between the inorganic magnetic layers 30B and a high magnetic layer ratio can be achieved. Furthermore, a stacking structure that includes the inorganic insulating layers 30A made of TaO, SiO₂, or the like and disposed between the inorganic insulating layers 30B can insulate the inorganic magnetic layers 30B from each other and suppress eddy current in the inorganic magnetic layers 30B, so that the inductor component 2 having a high Q value at a high frequency can be achieved.

The Q value is also referred to as a quality factor and indicates “sharpness” of a signal at a resonant frequency. A ratio (R/2πf·L) of an inductance L according to a frequency f to a resistance (R) of an inductor wiring line is referred to as a loss factor, and the Q value corresponds to an inverse of the loss factor. A higher Q value indicates a smaller loss and excellent characteristics as a high-frequency inductor.

If CZT (Co—Zr—Ta), an FeNi alloy, or the like as each of the inorganic magnetic layers 30B has a large thickness, eddy current generates in the magnetic layer. The inorganic magnetic layers 30B are thus preferably small in thickness. Specifically, the inorganic magnetic layers 30B are preferably smaller in thickness than a skin depth obtained from a circuit operation frequency such as a switching frequency of a DC-DC converter. Meanwhile, an inductor is a current element, so that the inductor wiring lines 10 are preferably larger in thickness for a large current flow.

In view of these, in the inductor component 2 according to the present embodiment, the first magnetic layer 30 is smaller in thickness than the inductor wiring lines 10. The inorganic magnetic layers 30B having a small thickness can suppress generation of eddy current in the inorganic magnetic layers 30B. In addition, the inductor wiring lines 10 having a large thickness can achieve the inductor component 2 having low direct current resistance and high inductor acquisition efficiency.

Furthermore, the first magnetic layer 30 according to the present embodiment includes the multilayer body including the inorganic insulating layers 30A and the inorganic magnetic layers 30B, and is provided on its surface with one of the inorganic insulating layers 30A. The inorganic insulating layer 30A provided on the surface of the first magnetic layer 30 can reliably achieve insulation from a peripheral member such as a wiring line. This applies also to the second magnetic layer 40 to be described later.

The magnetic layer can alternatively be constituted by a composite containing an organic resin and a magnetic filler in place of the multilayer body including the inorganic insulating layers 30A and the inorganic magnetic layers 30B. Examples of the organic resin may include epoxy, acryl, a phenol resin, or a combination of these resins, whereas examples of the magnetic filler may include ferrite, an Fe filler, or an Fe alloy. There may be further included an insulating filler such as a silica filler for adjustment of insulation characteristics and a coefficient of linear expansion. For example, epoxy resin can be adopted as the organic resin, and FeSiCr can be adopted as the inorganic filler.

After the first magnetic layer 30 is stacked on the first insulating layer 50A as described above and shown in C1 of FIG. 7C, the second insulating layer 50B is stacked on the first magnetic layer 30 formed as described above as shown in C2. Similarly to the first insulating layer 50A, polyimide as an organic resin can be applied onto the first magnetic layer 30 and cured to form the second insulating layer 50B. As shown in FIGS. 2A and 2B, the first magnetic layer 30 is disposed on the first insulating layer 50A to have the ends distant from both ends of the first insulating layer 50A, and the second insulating layer 50B is stacked thereon, so that a state where the second insulating layer 50B covers a side surface of the first magnetic layer 30 can be achieved.

### Step 4

As shown in FIG. 7D, the method subsequently includes Step 4 of forming the inductor wiring line 10 in accordance with an electrolytic plating method on the second insulating layer 50B formed in Step 3. Specifically, the first insulating layer 50A is provided thereon with a seed layer made of Ti/Cu in accordance with a sputtering method. A dry film resist (DFR) is then laminated on the seed layer, and the seed layer shaped correspondingly to the inductor wiring line is exposed by photolithography. Electricity is then supplied from the seed layer, and a plated portion is deposited on the seed layer thus exposed in accordance with the electrolytic plating method to form an inductor wiring line. The dry film resist (DFR) is then removed and the seed layer is etched to obtain an independent inductor wiring line thus insulated.

### Step 5

As shown in FIG. 7E, the method subsequently includes Step 5 of stacking the third insulating layer 52 on the second insulating layer 50B provided with the inductor wiring line 10 formed in Step 4. Specifically, similarly to the first insulating layer 50A and the second insulating layer 50B, polyimide as an organic resin can be applied and cured to form the third insulating layer 52. The third insulating layer 52 is thus formed to cover a side surface and an upper surface of the inductor wiring line 10. The second insulating layer 50B and the third insulating layer 52 are thus formed to surround the inductor wiring line 10.

### Step 6

As shown in FIG. 7F, the method subsequently includes Step 6 of stacking the second magnetic layer 40 on the third insulating layer 52 formed in Step 5. The second magnetic layer 40 can be stacked through a step similar to the step for the first magnetic layer 30, and can be provided with the inclined portions 42 each having a forward tapered surface or an inversely tapered surface similarly to the first magnetic layer 30. Furthermore, the easy axis of the inorganic magnetic layer can be directed in the applied magnetic field direction in the magnetic field in accordance with the sputtering method. When the applied magnetic field direction is unified during formation of the first magnetic layer 30 and the second magnetic layer 40, the first magnetic layer 30 and the second magnetic layer 40 can achieve uniaxial magnetic anisotropy in an identical axis direction.

### Step 7

As shown in FIG. 7G, the method subsequently includes Step 7 of forming via holes from the surface of the second magnetic layer 40 formed in Step 6. Specifically, laser light is applied from the surface of the second magnetic layer 40 to remove part of the second magnetic layer 40 and the second insulating layer 50B and form via holes BH reaching the pad portions 10A and 10B of the inductor wiring line 10. The via holes BH thus formed are gradually reduced in size from the surface of the second magnetic layer.

### Step 8

As shown in FIG. 7H, the method subsequently includes Step 8 of forming the vertical wiring lines 20 respectively in the via holes BH formed in Step 7. Formation of the via holes BH by application of laser light generates a resin residue called a smear. Initially executed is desmear treatment of removing such a smear (resin residue) generated by laser processing. After the via holes BH are cleaned through the desmear treatment, the vertical wiring lines 20 are formed respectively in the via holes BH. The vertical wiring lines 20 can be formed respectively in the via holes BH by electrolytic plating similar to that for formation of the inductor wiring line 10 described above. However, the method of forming the vertical wiring lines 20 is not limited to this, and can alternatively be formed through SAP (electroless plating, semi-additive process). The use of SAP allows the vertical wiring lines 20 having low resistance to be formed at a low cost. The vertical wiring lines 20 can alternatively be formed by a method other than SAP, such as a plating method, a sputtering method, an evaporation method, or an application method.

### Step 9

As shown in FIG. 7J, the method includes, subsequently to Step 8, Step 9 of grinding the substrate material S to obtain the substrate 60 having a predetermined thickness. However, the method is not limited to this, and Step 9 can be skipped if the substrate material S preliminarily has the predetermined thickness. For example, when the substrate material S is provided thereon with a provisionally stuck layer and the first insulating layer 50A is formed thereon, the substrate material S can be removed from the first insulating layer 50A after execution of Step 1 to Step 8. This can achieve the inductor component 6 including no substrate as shown in FIG. 10.

### Step 10

As shown in FIG. 7K, the method subsequently includes Step 10 of individualizing by means of the cutting tool subsequently to Step 9 (Step 8 in some case).

FIG. 7L shows the inductor component 2 formed by individualization in Step 10.

### Variations of First Embodiment

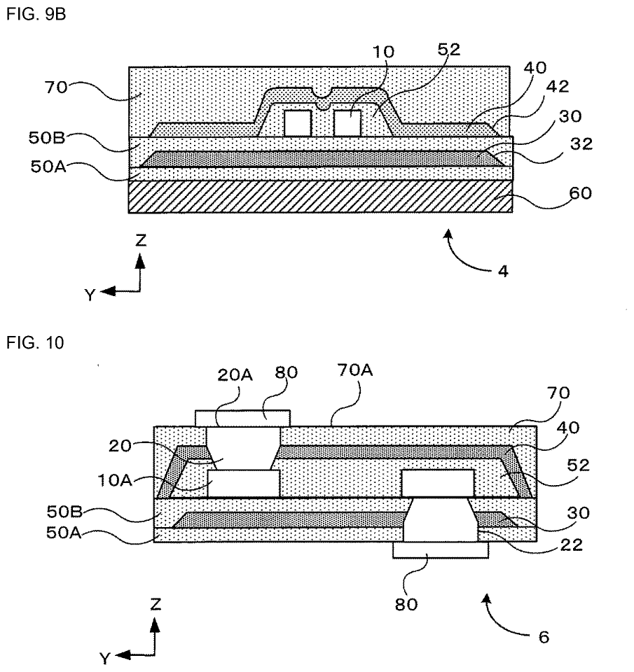

Described next are variations of the first embodiment with reference to FIGS. 9A to 13B.

### Variation 1

An inductor component according to Variation 1 of the first embodiment will be initially described with reference to FIGS. 9A and 9B. FIG. 9A is a view schematically showing the inductor component according to Variation 1 of the first embodiment of the present disclosure, specifically, a side sectional view showing a section positioned identically to the section shown in FIG. 2A. FIG. 9B is a view schematically showing the inductor component according to Variation 1 of the first embodiment of the present disclosure, specifically, a side sectional view showing a section positioned identically to the section shown in FIG. 2B.

Variation 1 provides an inductor component 4 that is different from the inductor component 2 according to the first embodiment in that a fourth insulating layer 70 is formed on the surface of the stacked second magnetic layer 40. The fourth insulating layer 70 surrounds side surfaces of the vertical wiring lines 20. The fourth insulating layer 70 as an inorganic insulating layer can be made of a material that is the same as or different from the material for the first and second insulating layers 50A and 50B and the third insulating layer 52.

According to Variation 1, the first magnetic layer 30 is covered with the first and second insulating layers 50A and 50B and the second magnetic layer 40 is covered with the second insulating layer 50B, the third insulating layer 52, and the fourth insulating layer 70, so that the first magnetic layer 30 and the second magnetic layer 40 can be protected from an environmental load (e.g. humidity).

Furthermore, the fourth insulating layer 70 covering the second magnetic layer 40 and constituting an outermost surface of an inductor component 8 has a surface flatter than the protruding and recessed shape of the second magnetic layer 40, so that mounting coplanarity can be improved. Coplanarity means “co-planarity” and indicates a property or state in which a plurality of points is positioned in an identical plane. Coplanarity may also be referred to as “surface uniformity” or “terminal flatness”.

As shown in FIG. 9A, the fourth insulating layer 70 covers the side surfaces of the vertical wiring lines 20 to suppress current leakage toward the second magnetic layer 40 and the like.

The fourth insulating layer 70 includes a surface 70A that is formed at an identical level to the end surfaces 20A of the vertical wiring lines 20, and an external terminal 80 is formed to be in contact with the surface 70A of the fourth insulating layer 70 and one of the end surfaces 20A of the vertical wiring lines 20. The external terminal 80 can be formed by electrolytic plating, the sputtering method, electroless plating, or the like similarly to the vertical wiring line 20.

The external terminal 80 extending along a plane overlaps with the second magnetic layer 40 when the plane is viewed in the vertical direction. That is, the external terminal 80 extends outward beyond the vertical wiring line 20 in plan view. The external terminal 80 is provided in this manner to be connected to the vertical wiring line 20 and extend along the plane. The external terminal 80 is formed to overlap with the second magnetic layer 40 when the plane is viewed in the vertical direction. Accordingly, the external terminal 80 can be increased in size, can be reduced in electrical resistance, and can be improved in fixing strength.

### Variation 2

An inductor component according to Variation 2 of the first embodiment will be described next with reference to FIG. 10. FIG. 10 is a view schematically showing the inductor component according to Variation 2 of the first embodiment of the present disclosure, specifically, a side sectional view showing a section positioned identically to the section shown in FIG. 2A.

Variation 2 provides the inductor component 6 that does not include the substrate 60. The inductor component 6 can be reduced in thickness due to exclusion of the substrate 60. Furthermore, similarly to Variation 1 described above, one of the vertical wiring lines 20 (the vertical wiring line on a left side in the figure) connected to the pad portion 10A of the inductor wiring line 10 is covered with the fourth insulating layer 70, and the end surface 20A of the vertical wiring line 20 is provided with the external terminal 80.

Meanwhile, a vertical wiring line 22 as the other one of the vertical wiring lines (the vertical wiring line on a right side in the figure) is connected to a surface adjacent to the first magnetic layer 30 (on a lower side in the figure) of the pad portion 10B of the inductor wiring line 10. The vertical wiring line 22 extends through the first magnetic layer 30 to protrude outward. According to Variation 2, the vertical wiring lines 20 and 22 extend to both sides of the inductor wiring line 10. This enables connection to an external circuit from either one of upper and lower sides, thus enhancing enhance flexibility in mounting site. Furthermore, the inductor component 6, including no substrate, can be reduced in thickness.

Alternatively, the inductor component 6 may include the substrate 60 as an inorganic substrate and the vertical wiring line 22 may extend through the substrate 60. The inductor component 6 thus configured can be connected to an external circuit from either one of the upper and lower sides to enhance flexibility in mounting site, and can also ensure substrate strength due to provision of the inorganic substrate.

According to Variation 2, the vertical wiring lines 20 and 22 extend through the first magnetic layer 30 and the second magnetic layer 40. If the vertical wiring line 20 (22) extends through at least one of the first magnetic layer 30 or the second magnetic layer 40, the magnetic flux passing through the magnetic layers 30 and 40 increases, so that higher inductance acquisition efficiency can be achieved.

### Variation 3

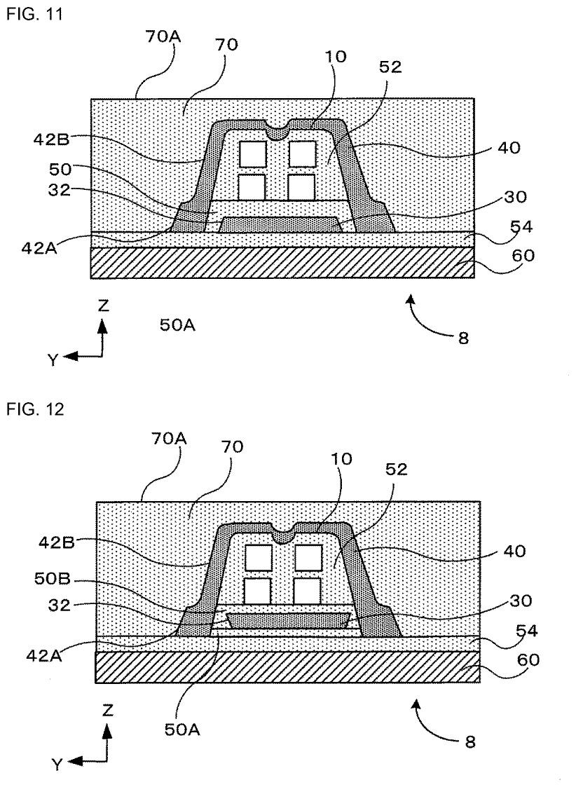

An inductor component according to Variation 3 of the first embodiment will be described next with reference to FIGS. 11 and 12. FIG. 11 is a view schematically showing the inductor component according to Variation 3 of the first embodiment of the present disclosure, specifically, a side sectional view showing a section positioned identically to the section shown in FIG. 2B, in a case where the end portions of the first magnetic layer include forward tapered surfaces. FIG. 12 is a view schematically showing the inductor component according to Variation 3 of the first embodiment of the present disclosure, specifically, a side sectional view showing a section positioned identically to the section shown in FIG. 2B, in a case where the end portions of the first magnetic layer include inversely tapered surfaces.

Variation 3 provides the inductor component 8 that includes the inductor wiring lines 10 extending along a plane and including a plurality of layers. According to examples shown in FIGS. 11 and 12, the two inductor wiring lines 10 disposed along the plane constitute two layers. That is, the inductor wiring lines 10 are disposed in a 2×2 matrix shape in sectional view. An insulating material (the third insulating layer 52) is provided between the layers of the inductor wiring lines 10. However, the inductor wiring lines 10 are not limited to this configuration, and the inductor component 8 can alternatively have a matrix shape including an appropriate number of inductor wiring lines 10 that are disposed along a plane and constitute an appropriate number of layers.

In this manner, when the inductor wiring lines 10 extending along the plane include a plurality of layers, the inductor wiring lines 110 are enhanced in flexibility. Furthermore, when an insulating resin as an insulating material is provided between the inductor wiring lines 10, current leakage can be suppressed and the inductor wiring lines 10 can be disposed closer to each other, so that the inductor component 8 having a small thickness can be achieved.

Variation 3 includes the example shown in FIG. 11, in which an insulating layer 54 is formed on the substrate 60, the first magnetic layer 30 is formed thereon, and an insulating layer 50 is formed to cover the first magnetic layer 30. Meanwhile, FIG. 12 shows the other example of disposition of the first magnetic layer 30. The insulating layer 54 is formed on the substrate 60, the first insulating layer 50A is formed thereon, the first magnetic layer 30 is formed thereon, and the second insulating layer 50B is further formed to cover the first magnetic layer 30. The second magnetic layer 40 is formed to cover a side surface of the insulating layer 50 or side surfaces of the first and second insulating layers 50A and 50B covering the first magnetic layer 30, in addition to a side surface of the third insulating layer 52 covering the inductor wiring lines 10. The second magnetic layer 40 is thus formed on the insulating layer 54. Accordingly, the first magnetic layer 30 and the second magnetic layer 40 can be regarded as being disposed in an identical plane in the example shown in FIG. 11. When the first magnetic layer 30 and the second magnetic layer 40 sandwiching the inductor wiring lines 10 are at least partially disposed in an identical plane parallel to the plane, the first magnetic layer 30 and the second magnetic layer 40 can cover the entire periphery, inclusive of the side surfaces, of the inductor wiring lines 10. This configuration can suppress a leakage magnetic flux.

As is apparent from FIGS. 11 and 12, the second magnetic layer 40 thus configured is larger in volume than the first magnetic layer 30. The second magnetic layer 40 can thus cover the inductor wiring lines 10, so that a leakage magnetic flux can be suppressed and the inductor acquisition efficiency improves.

Furthermore, the second magnetic layer 40 covers the inductor wiring lines 10, the first magnetic layer 30, and the first and second insulating layers 50A and 50B covering the first magnetic layer 30. Such a configuration isolates the first magnetic layer 30 from the second magnetic layer 40, so that eddy current between the magnetic layers can be suppressed.

Moreover, as is apparent from FIGS. 11 and 12, the second magnetic layer 40 covering the side surfaces of the inductor wiring lines 10 includes inclined portions 42A and 42B having a plurality of inclinations. According to the example shown, the inclined portion 42B located on an upper side in the figure is inclined more gently than the inclined portion 42A located on a lower side thereof. The inclined portions 42A and 42B of the second magnetic layer 40 having the plurality of inclinations can enhance flexibility for covering the side surfaces and can suppress breaking of the inductor wiring lines 10 during formation of the magnetic layer. When the inclined portions 42A and 42B of the second magnetic layer 40 are referred to as a first portion, the first portion can also be expressed as having a plurality of inclinations.

Furthermore, the second magnetic layer 40 covers the side surfaces of the inductor wiring lines 10 with the third insulating layer 52 interposed therebetween, and the inclined portions 42A and 42B of the second magnetic layer 40 are gentler in inclination than the side surfaces of the inductor wiring lines 10. The third insulating layer 52 thus interposed can suppress current leakage between the second magnetic layer 40 and the inductor wiring lines 10. Moreover, the second magnetic layer 40 is gentler in inclination than the side surfaces of the inductor wiring lines 10. The second magnetic layer 40 can thus be formed reliably without breaking the inductor wiring lines 10. When the inclined portions 42A and 42B of the second magnetic layer 40 are referred to as the first portion, the first portion can be expressed as being gentler in inclination from a direction perpendicular to the plane than the side surfaces of the inductor wiring lines 10.

According to the example shown in FIG. 11, both the inclined portions 32 of the first magnetic layer 30 and the inclined portions 42 of the second magnetic layer 40 have forward tapered surfaces. This can balance inductance acquisition efficiency with direct current superposition. In contrast, according to the example shown in FIG. 12, the inclined surfaces of the first magnetic layer 30 are inversely tapered surfaces whereas the inclined portions of the second magnetic layer 40 have forward tapered surfaces. The magnetic layer volume thus increases in the region adjacent to the inductor wiring lines 10 in each of the first magnetic layer 30 and the second magnetic layer 40, so that the more magnetic flux passes to improve inductance acquisition efficiency.

### (Inclined Portions According to Variation)

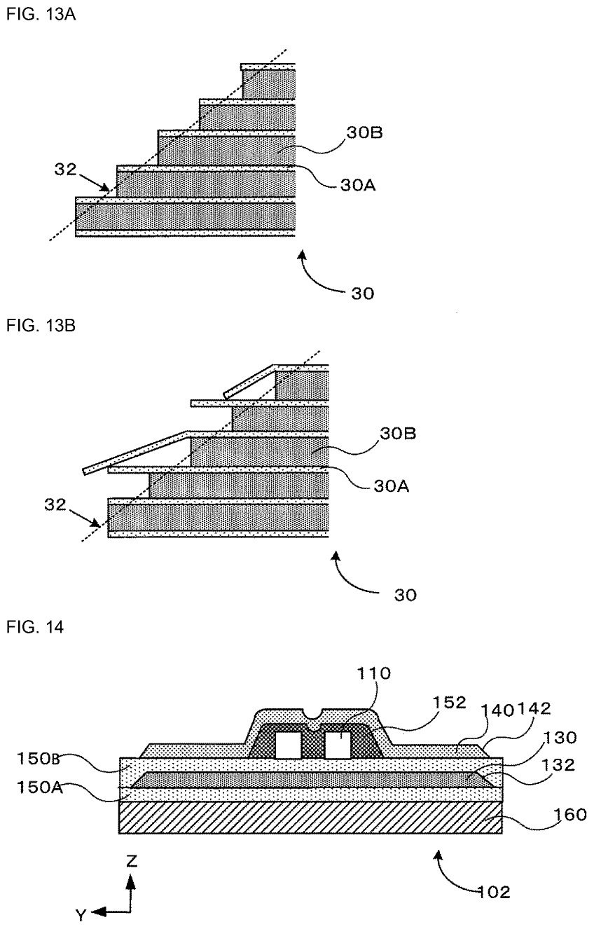

Described next with reference to FIGS. 13A and 13B are the inclined portions 32 and 42 of the first magnetic layer 30 and the second magnetic layer 40 according to a variation. FIGS. 13A and 13B are side sectional views schematically showing an exemplary case in which inorganic insulating layers and inorganic magnetic layers are stacked in a stepped manner to form an inclined portion.

In the inclined portion according to the variation shown in FIGS. 13A and 13B, the inorganic insulating layers 30A and the inorganic magnetic layers 30B are stacked in a stepped manner. Such a stepped stack shape can be formed by differentiating etching rates of the inorganic insulating layers 30A and the inorganic magnetic layers 30B. The inclined portion formed by stacking the inorganic insulating layers 30A and the inorganic magnetic layers 30B in a stepped manner functions similarly to the inclined portions 32. Specifically, when end portions of the inorganic magnetic layers 30B are connected by a straight line in accordance with a method of least squares, a stepped surface can be regarded as an inclined surface having an inclination indicated by the straight line (see dotted lines in FIGS. 13A and 13B).

In this case, as shown in FIG. 13B, the inorganic insulating layers 30A may protrude from the inorganic magnetic layers 30B or the inorganic magnetic layers 30B may protrude and be bent. However, no problem occurs since the inclined surface is defined by the inorganic magnetic layers 30B. The second magnetic layer 40 can be similarly provided with an inclined portion by stacking inorganic insulating layers and inorganic magnetic layers in a stepped manner. As described above, the inclined portions 32 and 42 can be formed on the first and second magnetic layers 30 and 40 in various manners.

### (Inductor Component According to Second Embodiment of the Present Disclosure)

An inductor component according to a fourth embodiment of the present disclosure will be described next with reference to FIG. 14. FIG. 14 is a view schematically showing an inductor component 102 according to the second embodiment of the present disclosure, specifically, a side sectional view showing a section positioned identically to the section shown in FIG. 2B.

The inductor component 102 according to the second embodiment has a planar shape similarly to the inductor component 2 according to the first embodiment. That is, the two inductor wiring lines 110 include both regions in which the two inductor wiring lines 110 are disposed parallel to each other and regions in which the two inductor wiring lines 110 are disposed nonparallel to each other. However, the inductor component is not limited to this configuration, and an inductor may include a meander wiring line extending in the longitudinal direction (X axis direction) while meandering.

In the inductor component 2 according to the first embodiment, the third insulating layer 52 is formed to surround the inductor wiring lines 10 formed on the second insulating layer 50B. The inductor component 102 according to the second embodiment is different from the inductor component 2 in that the inductor component 102 includes a composite portion 152 made of an organic resin and an inorganic filler, in place of the insulating layer, to surround the inductor wiring lines 110 formed on a second insulating layer 150B.

The inductor component 102 according to the second embodiment includes the magnetic composite portion 152 containing the organic resin and the inorganic filler and disposed between a first magnetic layer 130 and a second magnetic layer 140 as inorganic magnetic layers. The composite portion 152 is a composite containing the organic resin and the magnetic filler. Examples of the organic resin may include epoxy, acryl, a phenol resin, or a combination of these resins, whereas examples of the magnetic filler may include ferrite, an Fe filler, or an Fe alloy. There may be further included an insulating filler such as a silica filler for adjustment of insulation characteristics and a coefficient of linear expansion. The present embodiment adopts epoxy resin as the organic resin, and FeSiCr as the inorganic filler.

Si and Cr thus contained provide crystal strain in the magnetic composite portion 152, so that the magnetic layers can be increased in magnetic permeability. Si thus contained particularly provides crystal strain, so that the magnetic permeability of the magnetic layers can be improved in comparison to a case where only Fe is contained. Cr, which is likely to be oxidized, provided on a surface is oxidized to prevent oxidation inside the magnetic composite portion 152. In this manner, the magnetic composite portion 152 containing Si and Cr can balance magnetic saturation with magnetic permeability of the magnetic layers and can improve magnetic permeability of the magnetic layers, to improve reliability of the inductor component 102.

Magnetic permeability of the magnetic layers is improved if the first magnetic layer 130 and the second magnetic layer 140 are disposed closer to each other. However, eddy current may increase in the magnetic layers to decrease the Q value in this case. However, the inductor component 102 according to the present embodiment includes the magnetic composite portion 152 containing the organic resin and the inorganic filler and interposed between the first magnetic layer 130 and the second magnetic layer 140. Accordingly, eddy current can be suppressed even when the first magnetic layer 130 and the second magnetic layer 140 are disposed closer to each other, and the inductor component 102 can be reduced in thickness.

Furthermore, even when the first magnetic layer 130 and the second magnetic layer 140 are disposed closer to each other, the magnetic composite portion 152 can suppress eddy current and can thus increase the Q value. The present embodiment can thus provide the inductor component 102 that suppresses eddy current to increase the Q value even when the two magnetic layers are disposed closer to each other, as well as is small in thickness.

### (General)

As described above, the inductor component 2 or 102 according to any one of the embodiments includes the inductor wiring line 10 or 110 extending along the plane, the pad portions 10A and 10B or the like positioned at both ends of the inductor wiring line 10 or 110, the vertical wiring lines 20 or the like extending from the pad portions 10A and 10B or the like perpendicularly to the plane, and the first magnetic layer 30 or 130 and the second magnetic layer 40 or 140 sandwiching the inductor wiring line 10 or 110 in the direction perpendicular to the plane. In a sectional view orthogonal to the extending direction of the inductor wiring line 10 or 110, the first magnetic layer 30 or 130 and the second magnetic layer 40 or 140 each include the end portions including the inclined portions 32 and 42 or 132 and 142 inclined from the direction perpendicular to the plane.

The end portions of the first magnetic layer 30 or 130 and the second magnetic layer 40 or 140 include the inclined portions 32 and 42 or 132 and 142 in a sectional view of the inductor wiring line 10 or 110. The present disclosure can thus provide the inductor component 2 or 102 that can be changed in inductor characteristics without changing the wiring pattern of the inductor wiring line or forming a hole in the magnetic layers.

The present disclosure includes the following aspects.

<1> An inductor component including an inductor wiring line extending along a plane; a pad portion positioned at each end of the inductor wiring line; a vertical wiring line extending from the pad portion perpendicularly to the plane; and a first magnetic layer and a second magnetic layer sandwiching the inductor wiring line in a direction perpendicular to the plane. In a sectional view orthogonal to an extending direction of the inductor wiring line, the first magnetic layer and the second magnetic layer each include an end portion including an inclined portion inclined from the direction perpendicular to the plane.

<2> The inductor component according to <1>, wherein when an inclined surface that narrows the first magnetic layer or the second magnetic layer toward an inside of the end portion in a direction from the first magnetic layer toward the second magnetic layer is a forward tapered surface and an inclined surface that widens the first magnetic layer or the second magnetic layer toward an outside of the end portion in the direction from the first magnetic layer toward the second magnetic layer is an inversely tapered surface. Each of the inclined portions of the first magnetic layer and the second magnetic layer has a forward tapered surface.

<3> The inductor component according to <1>, wherein when an inclined surface that narrows the first magnetic layer or the second magnetic layer toward an inside of the end portion in a direction from the first magnetic layer toward the second magnetic layer is a forward tapered surface and an inclined surface that widens the first magnetic layer or the second magnetic layer toward an outside of the end portion in the direction from the first magnetic layer toward the second magnetic layer is an inversely tapered surface. Each of the inclined portions of the first magnetic layer and the second magnetic layer has an inversely tapered surface.

<4> The inductor component according to <1>, wherein when an inclined surface that narrows the first magnetic layer or the second magnetic layer toward an inside of the end portion in a direction from the first magnetic layer toward the second magnetic layer is a forward tapered surface and an inclined surface that widens the first magnetic layer or the second magnetic layer toward an outside of the end portion in the direction from the first magnetic layer toward the second magnetic layer is an inversely tapered surface. The inclined portion of the first magnetic layer has a forward tapered surface and the inclined portion of the second magnetic layer has an inversely tapered surface.

<5> The inductor component according to <1>, wherein when an inclined surface that narrows the first magnetic layer or the second magnetic layer toward an inside of the end portion in a direction from the first magnetic layer toward the second magnetic layer is a forward tapered surface and an inclined surface that widens the first magnetic layer or the second magnetic layer toward an outside of the end portion in the direction from the first magnetic layer toward the second magnetic layer is an inversely tapered surface. The inclined portion of the first magnetic layer has an inversely tapered surface and the inclined portion of the second magnetic layer has a forward tapered surface.

<6> The inductor component according to any one of <1> to <5>, wherein the vertical wiring line extends through at least one of the first magnetic layer or the second magnetic layer.

<7> The inductor component according to any one of <1> to <6>, wherein the first magnetic layer and the second magnetic layer are at least partially disposed in an identical plane parallel to the plane.

<8> The inductor component according to any one of <1> to <7>, wherein the second magnetic layer is larger in volume than the first magnetic layer.

<9> The inductor component according to any one of <1> to <8>, wherein when a surface of the inductor wiring line facing in a direction parallel to the plane is a side surface and a portion of the second magnetic layer covering the side surface with an insulating layer interposed therebetween is a first portion, the first portion is gentler in inclination from a direction perpendicular to the plane than the side surface.

<10> The inductor component according to any one of <1> to <9>, wherein when a surface of the inductor wiring line facing in a direction parallel to the plane is a side surface and a portion of the second magnetic layer covering the side surface with an insulating layer interposed therebetween is a first portion, the first portion includes a plurality of inclinations.

<11> The inductor component according to any one of <1> to <10>, further including an insulating layer covering the inductor wiring line and the first magnetic layer. The second magnetic layer covers the insulating layer.

<12> The inductor component according to any one of <1> to <11>, wherein the first magnetic layer and the second magnetic layer have uniaxial magnetic anisotropy in an identical direction. Both ends of the inductor wiring line are distant from each other along one of anisotropic axes including a hard axis and an easy axis in the uniaxial magnetic anisotropy, and the inductor wiring line extends without being orthogonal to the one of the anisotropic axes in an entire region.

<13> The inductor component according to <12>, wherein each of the first magnetic layer and the second magnetic layer includes a multilayer body including inorganic insulating layers and inorganic magnetic layers. The inorganic insulating layers are smaller in thickness than the inorganic magnetic layers, and all the inorganic magnetic layers have uniaxial magnetic anisotropy in an identical direction.

<14> The inductor component according to any one of <1> to <13>, wherein the first magnetic layer is formed on an inorganic substrate.

<15> The inductor component according to any one of <1> to <14>, wherein the inductor wiring line extending along the plane includes a plurality of layers, and an insulating material is provided between the layers of the inductor wiring line.

<16> The inductor component according to any one of <1> to <15>, wherein each of the first magnetic layer and the second magnetic layer is an inorganic magnetic layer, and a magnetic composite portion containing an organic resin and an inorganic filler is interposed between the first magnetic layer and the second magnetic layer.

The description of the above embodiments is exemplary in all respects and not limiting. Those skilled in the art can modify and change the embodiments as appropriate. The scope of the present disclosure is defined not by the above embodiments but by the claims. Furthermore, the scope of the present disclosure includes changes from the embodiments within the scope of the claims and equivalents thereof.

What is claimed is:

1. An inductor component comprising:
an inductor wiring line extending along a plane;
a pad portion at each end of the inductor wiring line;
a vertical wiring line extending from the pad portion perpendicularly to the plane; and
a first magnetic layer and a second magnetic layer sandwiching the inductor wiring line in a direction perpendicular to the plane, wherein
in a sectional view orthogonal to an extending direction of the inductor wiring line, the first magnetic layer and the second magnetic layer each include an end portion including an inclined portion inclined from the direction perpendicular to the plane.

2. The inductor component according to claim 1, wherein
when an inclined surface that narrows the first magnetic layer or the second magnetic layer toward an inside of the end portion in a direction from the first magnetic layer toward the second magnetic layer is a forward tapered surface and an inclined surface that widens the first magnetic layer or the second magnetic layer toward an outside of the end portion in the direction from the first magnetic layer toward the second magnetic layer is an inversely tapered surface,
each of the inclined portions of the first magnetic layer and the second magnetic layer has a forward tapered surface.

3. The inductor component according to claim 1, wherein
when an inclined surface that narrows the first magnetic layer or the second magnetic layer toward an inside of the end portion in a direction from the first magnetic layer toward the second magnetic layer is a forward tapered surface and an inclined surface that widens the first magnetic layer or the second magnetic layer toward an outside of the end portion in the direction from the first magnetic layer toward the second magnetic layer is an inversely tapered surface,
each of the inclined portions of the first magnetic layer and the second magnetic layer has an inversely tapered surface.

4. The inductor component according to claim 1, wherein
when an inclined surface that narrows the first magnetic layer or the second magnetic layer toward an inside of the end portion in a direction from the first magnetic layer toward the second magnetic layer is a forward tapered surface and an inclined surface that widens the first magnetic layer or the second magnetic layer toward an outside of the end portion in the direction from the first magnetic layer toward the second magnetic layer is an inversely tapered surface,
the inclined portion of the first magnetic layer has a forward tapered surface and the inclined portion of the second magnetic layer has an inversely tapered surface.

5. The inductor component according to claim 1, wherein
when an inclined surface that narrows the first magnetic layer or the second magnetic layer toward an inside of the end portion in a direction from the first magnetic layer toward the second magnetic layer is a forward tapered surface and an inclined surface that widens the first magnetic layer or the second magnetic layer toward an outside of the end portion in the direction from the first magnetic layer toward the second magnetic layer is an inversely tapered surface,
the inclined portion of the first magnetic layer has an inversely tapered surface and the inclined portion of the second magnetic layer has a forward tapered surface.

6. The inductor component according to claim 1, wherein
the vertical wiring line extends through at least one of the first magnetic layer or the second magnetic layer.

7. The inductor component according to claim 1, wherein
the first magnetic layer and the second magnetic layer are at least partially in an identical plane parallel to the plane.

8. The inductor component according to claim 1, wherein
the second magnetic layer is larger in volume than the first magnetic layer.

9. The inductor component according to claim 1, wherein
when a surface of the inductor wiring line facing in a direction parallel to the plane is a side surface and a portion of the second magnetic layer covering the side surface with an insulating layer interposed therebetween is a first portion, the first portion is gentler in inclination from a direction perpendicular to the plane than the side surface.

10. The inductor component according to claim 1, wherein
when a surface of the inductor wiring line facing in a direction parallel to the plane is a side surface and a portion of the second magnetic layer covering the side surface with an insulating layer interposed therebetween is a first portion, the first portion includes a plurality of inclinations.

11. The inductor component according to claim 1, further comprising:
an insulating layer covering the inductor wiring line and the first magnetic layer, wherein
the second magnetic layer covers the insulating layer.

12. The inductor component according to claim 1, wherein
the first magnetic layer and the second magnetic layer have uniaxial magnetic anisotropy in an identical direction,
both ends of the inductor wiring line are distant from each other along one of anisotropic axes including a hard axis and an easy axis in the uniaxial magnetic anisotropy, and
the inductor wiring line extends without being orthogonal to the one of the anisotropic axes in an entire region.

13. The inductor component according to claim 12, wherein
each of the first magnetic layer and the second magnetic layer includes a multilayer body including inorganic insulating layers and inorganic magnetic layers,
the inorganic insulating layers are smaller in thickness than the inorganic magnetic layers, and
all the inorganic magnetic layers have uniaxial magnetic anisotropy in an identical direction.

14. The inductor component according to claim 1, wherein
the first magnetic layer is on an inorganic substrate.

15. The inductor component according to claim 1, wherein
the inductor wiring line extending along the plane includes a plurality of layers, and an insulating material is between the layers of the inductor wiring line.

16. The inductor component according to claim 1, wherein
each of the first magnetic layer and the second magnetic layer is an inorganic magnetic layer, and a magnetic composite portion including an organic resin and an inorganic filler is interposed between the first magnetic layer and the second magnetic layer.

17. The inductor component according to claim 2, wherein
the vertical wiring line extends through at least one of the first magnetic layer or the second magnetic layer.

18. The inductor component according to claim 2, wherein
the first magnetic layer and the second magnetic layer are at least partially in an identical plane parallel to the plane.

19. The inductor component according to claim 2, wherein
the second magnetic layer is larger in volume than the first magnetic layer.

20. The inductor component according to claim 2, wherein
when a surface of the inductor wiring line facing in a direction parallel to the plane is a side surface and a portion of the second magnetic layer covering the side surface with an insulating layer interposed therebetween is a first portion, the first portion is gentler in inclination from a direction perpendicular to the plane than the side surface.
